(19) United States
(12) Patent Application Publication
(10) Pub. No.: US 2005/0235050 A1
(43) Pub. Date: Oct. 20, 2005

(54) Configuration of software applications on a target terminal

(76) Inventor: Keith Baker, Eindhoven (NL)

Correspondence Address: PHILIPS INTELLECTUAL PROPERTY & STANDARDS, P.O. BOX 3001, BRIARCLIFF MANOR, NY, 10510, US

(21) Appl. No.: 10/515,735

(22) PCT Filed: May 16, 2003
(86) PCT No.: PCT/IB03/02014

§ 371 Date: Nov. 24, 2004

(30) Foreign Application Priority Data
May 30, 2002 (EP) 02077134.1

(51) Int. Cl. G06F 15/177

(52) U.S. Cl. 709/220; 709/219

(57) ABSTRACT

The present invention relates to a method for configuring an application on a target terminal, comprising the steps of defining the configuration of said application via an application configuration service running on a configuration server, transmitting said defined configuration from said configuration server to said target terminal, configuring the application on the target terminal according to the configuration defined via the application configuration service. The method further comprises the step of checking the defined configuration for compliance with a set of predefined configuration rules, before configuring the application on said target terminal. The invention also relates to a configuration server for configuring an application on a target terminal.

The invention relates to a method for configuring an application on a target terminal, comprising the steps of defining the configuration of the application via an application configuration service running on a configuration server, transmitting the defined configuration from said configuration server to said target terminal and configuring the application on the target terminal according to the configuration defined via the application configuration service. The invention further relates to a configuration server for configuring an application on a target terminal.

The advent of microprocessors and other miniaturized electronics has facilitated the implementation of increasingly complex functions in home and office appliances—also referred to as target terminals.

Typically, a relatively complex operator interface is required in order to invoke the various functions that are available. For example, home electronic devices such as televisions, VCRs, stereo receivers and the like are typically provided with sophisticated remote control devices. Such remote control devices have a large number of individual buttons which are used directly to control features of an appliance and/or are used to navigate through on-screen menus. Because of the sophistication and complexity of the controls, owners manuals for appliances are becoming increasingly voluminous and difficult to comprehend.

Similarly, terminals in automotive systems such as car and trucks have embedded in-car sub-systems for navigation, entertainment and location based services. These terminals have the same constraints or tight constraints on the user interface as an in-home entertainment system. In order to configure and define such applications, a secondary terminal will be required.

Due to the growing complexity of modern appliances many of the available features are never utilized by consumers, even as competition in the marketplace drives the proliferation of such features. A number of solutions have been proposed for making appliances easier to control and more “user friendly” in general.

Further advanced set top boxes and IDTV include complex applications which provide the user with functionality comparable to that of a PC or similar. Nevertheless, the user interface for the TV typically needs to be controlled with simple input devices such as a classical infrared TV remote control and limited graphical user interfaces. These are less than ideal user interface devices for complex configuration tasks, as textual information is difficult to provide. In addition, if the application needs to be configured to the needs of the user(s) on an irregular basis, the configuration code is of low value to the user. Thus, those elements of the software needed for configuration (user interfaces) will consume a significant part of the memory without providing functionality to the user over the whole lifetime of the product.

WO 00 58817 describes a digital imaging device having a meta-language application defining the GUI (Guided User Interface) of the digital imaging device. The meta-language application can be updated on a server and posted to the camera whereby the GUI can be updated, and because it is a meta-language application which defines the GUI, it is not necessary to compile the application for different hardware platforms which reduces the cost, maintenance and time to market issues.

WO 00 43870 describes a method for setting programmable features of an appliance. The programmable features are set at an interactive site, where after the settings are downloaded from the site to a transfer device and from the transfer device to the appliance. Since the appliance itself does not require a user interface for set-up procedures and programming, the appliance can be smaller, cheaper and lighter without sacrificing any functionality.

In the above-mentioned documents, a method is described where the configuration of on application on a target terminal is changed at a central server and then the configuration settings are downloaded to the target terminal.

A problem with the above is that the possible configurations for specific target terminals typically depend on the compatibility and consistency with how the target terminals are set up as well as it depends on how the applications on the target terminals cooperate with the configuration.

It is therefore an object of the present invention to provide a method solving the above-mentioned problem.

This is obtained by the step of checking the defined configuration for compliance with a set of predefined configuration rules before configuring the application on said target terminal. The configuration of applications that have to be configured to work in co-operation with the application already resident in the target terminal can thereby be checked. This ensures that the defined configuration is possible and does not introduce incompatibility with the already resident applications. The configuration rules comprise information about the target terminal. Further, for reasons of warranty, the need for a secure and certified control of the configuration of applications by the vendor is paramount in systems such as automotive systems.

In an embodiment the step of checking the defined configuration for compliance with a set of predefined configuration rules is performed by the configuration service before the defined configuration is transmitted to the target terminal. The compliance check of the defined configuration can be more extensively performed on the configuration server, since there are no tight limits on the complexity of the configuration service software. Secondly, the configuration service software can easily be upgraded and modified to account for experience in the field.

In a specific embodiment the defined configuration is not in compliance with said set of predefined configuration rules. The configuration service prompts a user with information which makes it possible for said user to redefine the configuration in such a way that the redefined configuration is in compliance with the predefined configuration rules. Thereby it can easily be ensured that the defined configuration is in compliance with the configuration rules.

In another embodiment the set of configuration rules comprises rules which are specific for the target terminal. Thereby the rules can also comprise information about the specific set-up of the target terminal and it can be checked if the configuration is compatible with the specific set up of the target terminal, such as connections with external terminals.

In yet another embodiment the step of defining the configuration of the application is performed via a configuration terminal connected to the configuration server via a public communication network. By using a public communication network such as the Internet, a connection between a configuration terminal and a configuration server can easily be established. Further defined configuration data can easily be transmitted to the configuration terminal in order to be installed on the target terminal.

In a specific embodiment the defined configuration is transmitted from the configuration server to the target terminal via the configuration terminal. Thereby the target terminals having limited resources can access the configuration server indirectly by using the resources in a configuration terminal.

In an embodiment the defined configuration is transmitted directly from the configuration server to the target terminal. In the case of target terminals having resources for connecting to the configuration server via the public communication network, the configuration terminal can be avoided whereby the method is less complex. Further the configuration terminal could be used for defining the configuration and then the defined configuration is transmitted directly to the target terminal.

In another embodiment the defined configuration is encrypted using a certificate which is specific for said target terminal before said defined configuration is transmitted to said target terminal and said target terminal decrypts the defined configuration using the certificate being specific for said target terminal before configuring the application on said target terminal. Thereby it can be ensured that the defined configuration is secured from further modification, and the data cannot be used before the secured data are decrypted using the right certificate.

The invention further relates to a configuration server with means for checking the defined configuration for compliance with a set of predefined configuration rules, before transmitting the application to said target terminal.

In the following, preferred embodiments of the invention will be described referring to the figures, wherein

FIG. 1 illustrates an embodiment of a system for directly configuring applications on a target terminal,

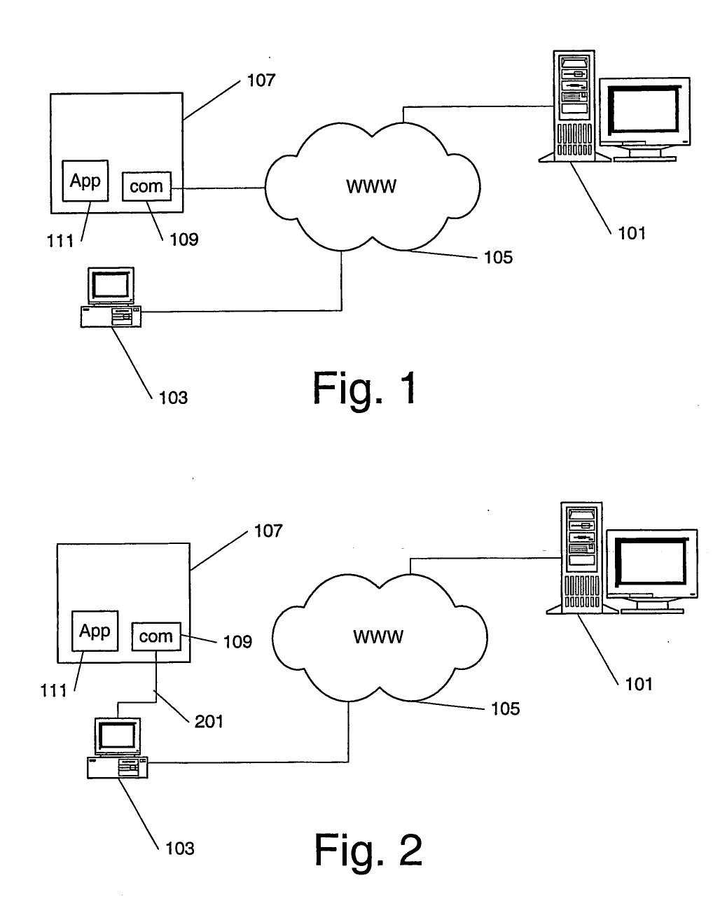

FIG. 2 illustrates another embodiment of a system for indirectly configuring applications on a target terminal,

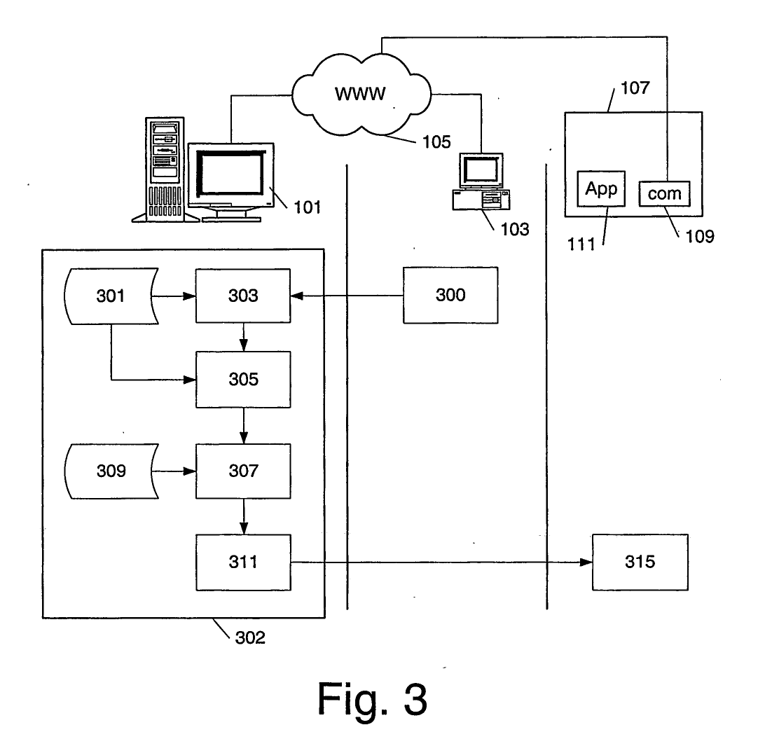

FIG. 3 illustrates a method of directly configuring applications on a target terminal,

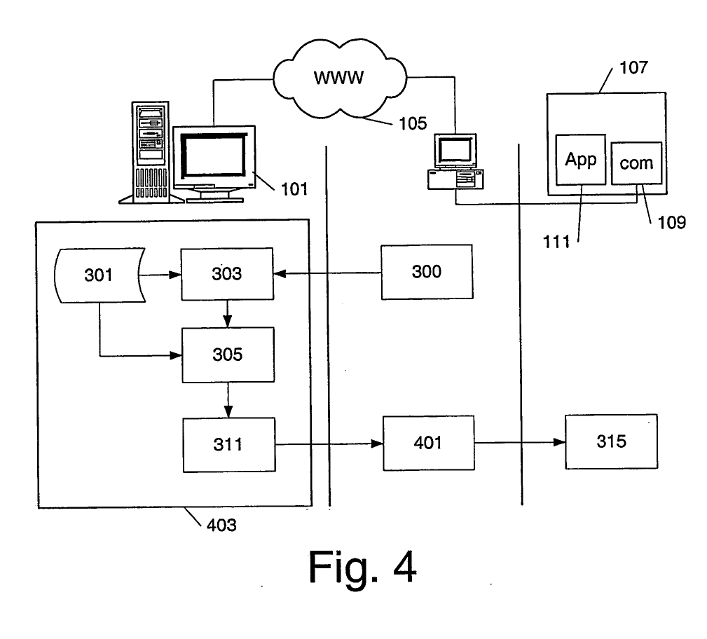

FIG. 4 illustrates a method of directly configuring applications on a target terminal.

FIG. 1 illustrates an embodiment of a system for directly configuring applications on a target terminal 107. A configuration server 101 is connected to the configuration terminal 103 via a network connection such as the World Wide Web (WWW) 105. The target terminal 107 is also connected to the configuration server 101 via a network connection such as the World Wide Web (WWW) 105. In this system the configuration terminal 103 accesses the configuration server 101 via the network connection 105 and defines configurations of applications 111 on the target terminal 107. When the configuration has been defined, the configuration server 101 first validates the defined configuration and updates the target terminal 107 directly by accessing the target terminal 107 via the network connection 105 through the communication port 109. The network connection could be IP networks of broadcast networks (DVB). The target terminal 107 could be a target terminal 107 already provided with means for accessing the Internet, such as an IDTV or a digital receiver or other terminals including a serial interface and a modem or a cable modem providing access to the Internet.

FIG. 2 illustrates an embodiment of a system for indirectly configuring applications on a target terminal 107. A configuration server 101 is connected to the configuration terminal 103 via a network connection such as the World Wide Web (WWW 105. The target terminal 107 is also connected to the configuration server 101 via a network connection such as the World Wide Web (WWW) 105. In this system the configuration terminal 103 accesses the configuration server (101) via the network connection 105 and defines configurations of applications 111 on the target terminal 107. When the configuration has been defined, the configuration server 101 first validates the defined configuration and updates the target terminal 107 indirectly by transmitting the defined configuration to the configuration terminal 103 via the network connection 105. The configuration terminal 103 then accesses the target terminal 107 via a connection 201 through the communication port 109. The connection 201 could be via a coupling of the configuration terminal 103 to the target terminal 107, i.e. RS232, USB or wireless, or wired network.

Other examples of target terminals could be digital cameras, playing consoles, televisions and other kinds of electronic equipment. The application configurations could include the form of the application 111 of the terminals such as the form of user interface applications (i.e. colour, skins, language, formats, and other graphic objects). Alternatively it could configure services provided to the application(s) by agents or applets or other web services used by server side services also supporting the target terminal application 111.

FIG. 3 illustrates a method of directly configuring applications 111 on a target terminal 107. The user accesses a configuration service 302 on the configuration server 101 from a configuration terminal 103 using rights given to him as the owner of a target terminal 107, these rights could e.g. be identified according to a serial number of the target terminal 107 or other identification information uniquely identifying the target terminal 107. The user then uses the configuration service 302 on the configuration server 101 to configure applications on the target terminal 107 to specific requirements. In 300 the configuration terminal 103 accesses the configuration service 302 on the configuration server 101 via an Internet browser such as Netscape© or Internet Explorer©. In an embodiment the target terminal supplier could provide access via a web site to the company's configuration service. The service is resident on the company's server, although components of this service could be plug-ins that are transferred to the configuration terminal 103 for installation in the browser. In 303 the configuration service 302 first receives the configuration definition from the user via the configuration terminal 103 e.g. by presenting information on how the target terminal 107 was previously configured, the target terminal could also present configuration alternatives. The information about previous configurations could be stored in a user database 301 which comprises information about configurations of applications on specific target terminals 107. The information stored in the database is stored together with a user id identifying the user who owns the specific target terminals 107 and who thereby has the rights to change the configuration of target terminal applications. When the user has finished defining the configuration of an application 111, the defined configuration is stored in the user database 301. Information about the defined configuration is generated within the configuration server 101. This information could be tables of data, or references to data tables stored on other servers, or it could include Java class files for the application 111. In 305 the defined configuration is checked for compliance with a set of predefined configuration rules. The configuration rules are stored in the user database 301 and comprise information about the specific target terminal 107 which is being configured. The information could e.g. be an identification of other applications on the target terminal 107 and also identification of other devices connected to the target terminal 107 which might limit the number of possible configurations of the specific target terminal application 111. This information could e.g. be entered when the user registers the purchase of the target terminal 107 and then each time the configuration rules changes. When the target terminal 107 is directly connected to the configuration server 101 via the Internet, the configuration tools could be updated automatically. Alternatively, the user could enter changes via the configuration terminal 103. Further, if the defined configuration is not in compliance with the configuration rules, the user might be prompted with possible alternatives which define a configuration being in compliance with the configuration rules. The check would include checks on the compatibility with other target terminal applications, but also the following areas could be:
Terminal security
Terminal owner profiles
Network security
Terminal supplier security (Contract arrangements)
Service provider security
Service provider billing arrangements
National, regional, legal and security arrangements

In 307 the compliance check has been completed and the data tables and Java object libraries can be secured from further modification. This secured and packaged bundle can then be issued with a security certificate via the configuration server provider's certification process which is connected to a certification source 309. This source could be at the configuration server 101 or at a separate server dedicated to be a certification server. The bundle can then be issued to the target terminal 107 for inclusion in the application data of the target terminal 107, e.g. as part of a user profile. In 311 transmission of the bundle is made via an appropriate transmission path. In this case the transmission path is directly from the configuration server 101 to the target terminal 107 and in this case additional security could be necessary to protect the bundle from interference. Once delivered to the target terminal 107 the bundle is unpacked; first the certificates are verified, and data could again be validated for compatibility with the current target terminal configuration and the application configuration (i.e. checking that the uptake is currently valid), and then the data are installed into the target application 111. A confirmation could be sent to the configuration server 101 to indicate that the task is complete.

FIG. 4 illustrates a method of indirectly configuring applications on a target terminal 107. In this case the configured data are transmitted to the configuration terminal 103 which then transmits the data to the target terminal 107. In this case either the configuration terminal 103 or the target terminal 107 could unpack the bundle and either of these could also perform the certification, verification and validation, after which the data is installed into the target application 111. Also, in this case a confirmation could be sent to the configuration server 101 to indicate that the task is complete; the confirmation could be send by either the configuration terminal 103 or by the target terminal 107.

In another embodiment the configuration terminal 103 is an integrated part of the target terminal 107. This could be the case if the target terminal 107 was a target terminal 107 already provided with means for accessing the Internet, such as an IDTV or a digital receiver.

1. A method for configuring an application on a target terminal, the method comprising the steps of:
defining the configuration of said application via an application configuration service running on a configuration server,
transmitting said defined configuration from said configuration server to said target terminal,
configuring the application on the target terminal according to the configuration defined via the application configuration service,
characterized in that the method further comprises the step of checking the defined configuration for compliance with a set of predefined configuration rules, before configuring the application on said target terminal.

2. A method according to claim 1, wherein the step of checking the defined configuration for compliance with a set of predefined configuration rules is performed by the configuration service before the defined configuration is transmitted to the target terminal.

3. A method according to claim 2, wherein if the defined configuration is not in compliance with said set of predefined configuration rules, the configuration service prompts a user with information making it possible for said user to redefine the configuration in such a way that the redefined configuration is in compliance with the predefined configuration rules.

4. A method according to claim 1, wherein the set of configuration rules comprises rules being specific for the target terminal.

5. A method according to claim 1, wherein the step of defining the configuration of the application is performed via a configuration terminal connected to the configuration server via a public communication network.

6. A method according to claim 5, wherein the defined configuration is transmitted from the configuration server to the target terminal via the configuration terminal.

7. A method according to claim 1, wherein the defined configuration is transmitted directly from the configuration server to the target terminal

8. A method according to claim 1, wherein the defined configuration is encrypted using a certificate being specific for said target terminal before said defined configuration is transmitted to said target terminal and said target terminal decrypts the defined configuration using the certificate being specific for said target terminal before configuring the application on said target terminal.

9. A configuration server for configuring an application on a target terminal, the apparatus comprises:
means for defining the configuration of said application via an application configuration service running on a configuration server,
transmitting said defined configuration from said configuration server to said target terminal, said target terminal being adapted for configuring said application according to said configuration defined on said application configuration server,
characterized in that the configuration server further comprises means for checking the defined configuration for compliance with a set of predefined configuration rules, before transmitting the defined configuration to said target terminal.
